(19) United States
(12) Patent Application Publication
(10) Pub. No.: US 2025/0196162 A1
(43) Pub. Date: Jun. 19, 2025

(54) MODULARIZED IONIZER ENVELOPE

(71) Applicant: B/E AEROSPACE, INC., Winston Salem, NC (US)

(72) Inventors: Srinivas Magaji Gundu, Bangalore (IN); Hemanth Raghav Gajendra, Bangalore (IN)

(73) Assignee: B/E AEROSPACE, INC., Winston Salem, NC (US)

(21) Appl. No.: 18/617,410

(22) Filed: Mar. 26, 2024

(30) Foreign Application Priority Data
Dec. 19, 2023 (IN) 202341086855

(51) Int. Cl. B03C 3/82; B03C 3/66

(52) U.S. Cl. CPC B03C 3/82; B03C 3/66

(57) ABSTRACT

A modular case for an air ionizer is disclosed herein. The modular case includes a top compartment having a first opening, the top compartment configured to house a first circuit board, a removable compartment configured to house a second circuit board, the removable compartment physically and electrically isolating the second circuit board from the first circuit board, a front compartment having a second opening, the front compartment coupled to and disposed below the top compartment, the front compartment configured to receive and house the removable compartment, a top lid configured to cover the first opening, and a front lid configured to cover the second opening.

### CROSS-REFERENCE TO RELATED APPLICATIONS

This application claims priority to, and the benefit of, India patent application No. 202341086855, filed Dec. 19, 2023 (DAS code D99A) and titled “MODULARIZED IONIZER ENVELOPE,” which is incorporated by reference herein in its entirety for all purposes.

### FIELD

The present disclosure generally relates to an air ionizer enclosure, and more particularly to a modular air ionizer enclosure.

### BACKGROUND

Air ionizers are being disposed in various locations to mitigate odors from electrical fumes, smoke, molds, dust, malodorous substances, whether organic or inorganic, and pathogens through ionization. The enclosures used by the air ionizers are generally customized to the specific task and location for which the air ionizer was designed. The customized designs of the enclosures and electronics tends to increase the cost and time for manufacturing the air ionizer.

### SUMMARY

Disclosed herein is a modular case for an air ionizer. The modular case includes a top compartment having a first opening, the top compartment configured to house a first circuit board, a removable compartment configured to house a second circuit board, the removable compartment physically and electrically isolating the second circuit board from the first circuit board, a front compartment having a second opening, the front compartment coupled to and disposed below the top compartment, the front compartment configured to receive and house the removable compartment, a top lid configured to cover the first opening, and a front lid configured to cover the second opening.

In various embodiments, the modular case further includes a front wall, a back wall, a first sidewall coupled to the front wall and the back wall, a second sidewall coupled to the front wall and the back wall, and a divider coupled to the front wall, the back wall, the first sidewall, and the second sidewall, the divider separating the top compartment from the front compartment, wherein the front wall, the back, the first sidewall, the second sidewall, and the divider define the top compartment. In various embodiments, the modular case further includes a bottom panel coupled to the back wall, the first sidewall, and the second sidewall, wherein the bottom panel, the back wall, the first sidewall, the second sidewall, and the divider define the front compartment.

In various embodiments, the first opening opens in a first direction and the second opening opens in a second direction orthogonal to the first direction. In various embodiments, the removable compartment includes a bottom panel, a first sidewall coupled to a first side of the bottom panel, a second sidewall coupled to a second side of the bottom panel opposite the first side, a third sidewall coupled to a third side of the bottom panel and extending from the first sidewall to the second sidewall, and a fourth sidewall coupled to a fourth side of the bottom panel and extending from the first sidewall to the second sidewall, the fourth side being opposite the third side.

In various embodiments, the removable compartment includes a material having a high dielectric to electrically isolate the second circuit board from the first circuit board. In various embodiments, the modular case further includes a communication connector coupled to the top compartment, the communication connector configured to operatively connect to the first circuit board.

Also disclose herein is an air ionizer including a high voltage circuit board, a low voltage circuit board operatively coupled to the high voltage circuit board, and a modular case. The modular case includes a top compartment having a first opening, the top compartment configured to house the low voltage circuit board, a removable compartment configured to house the high voltage circuit board, the removable compartment physically and electrically isolating the high voltage circuit board from the low voltage circuit board, a front compartment having a second opening, the front compartment coupled to and disposed below the top compartment, the front compartment configured to receive and house the removable compartment, a top lid configured to cover the first opening, and a front lid configured to cover the second opening.

In various embodiments, the modular case further includes a front wall, a back wall, a first sidewall coupled to the front wall and the back wall, a second sidewall coupled to the front wall and the back wall, and a divider coupled to the front wall, the back wall, the first sidewall, and the second sidewall, the divider separating the top compartment from the front compartment, wherein the front wall, the back, the first sidewall, the second sidewall, and the divider define the top compartment. In various embodiments, the modular case further includes a bottom panel coupled to the back wall, the first sidewall, and the second sidewall, wherein the bottom panel, the back wall, the first sidewall, the second sidewall, and the divider define the front compartment.

In various embodiments, the air ionizer further includes a feedback circuit board, wherein the top compartment is further configured to house the feedback circuit board. In various embodiments, the air ionizer further includes a communication connector coupled to the top compartment and operatively coupled to the low voltage circuit board. In various embodiments, the removable compartment includes a material having a high dielectric to electrically isolate the high voltage circuit board from the low voltage circuit board.

In various embodiments, the removable compartment includes a bottom panel, a first sidewall coupled to a first side of the bottom panel, a second sidewall coupled to a second side of the bottom panel opposite the first side, a third sidewall coupled to a third side of the bottom panel and extending from the first sidewall to the second sidewall, and a fourth sidewall coupled to a fourth side of the bottom panel and extending from the first sidewall to the second sidewall, the fourth side being opposite the third side.

Also disclosed herein is an air ionizer including a high voltage circuit board and a modular case. The modular case includes a top compartment having a first opening, a removable compartment including a high dielectric material and configured to house the high voltage circuit board, the removable compartment physically and electrically isolating the high voltage circuit board from the top compartment, a front compartment having a second opening, the front compartment coupled to and disposed below the top compartment, the front compartment configured to receive and house the removable compartment, a top lid configured to cover the first opening, and a front lid configured to cover the second opening.

In various embodiments, the removable compartment includes a bottom panel, a first sidewall coupled to a first side of the bottom panel, a second sidewall coupled to a second side of the bottom panel opposite the first side, a third sidewall coupled to a third side of the bottom panel and extending from the first sidewall to the second sidewall, and a fourth sidewall coupled to a fourth side of the bottom panel and extending from the first sidewall to the second sidewall, the fourth side being opposite the third side. In various embodiments, the air ionizer further includes a low voltage circuit board disposed in the top compartment, the low voltage circuit board operatively coupled to the high voltage circuit board.

In various embodiments, the air ionizer further includes a feedback circuit board disposed in the top compartment and operatively coupled to the low voltage circuit board. In various embodiments, the modular case further includes a front wall, a back wall, a first sidewall coupled to the front wall and the back wall, a second sidewall coupled to the front wall and the back wall, and a divider coupled to the front wall, the back wall, the first sidewall, and the second sidewall, the divider separating the top compartment from the front compartment, wherein the front wall, the back, the first sidewall, the second sidewall, and the divider define the top compartment.

In various embodiments, the modular case further includes a bottom panel coupled to the back wall, the first sidewall, and the second sidewall, wherein the bottom panel, the back wall, the first sidewall, the second sidewall, and the divider define the front compartment.

The foregoing features and elements may be combined in any combination, without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the following detailed description and claims in connection with the following drawings. While the drawings illustrate various embodiments employing the principles described herein, the drawings do not limit the scope of the claims.

FIG. 1A illustrates an exploded view of a modularized ionizer envelope, in accordance with various embodiments.

FIG. 1B illustrates a front view of a modularized ionizer envelope, in accordance with various embodiments.

FIG. 1C illustrates a top view of a modularized ionizer envelope, in accordance with various embodiments.

FIG. 1D illustrates a side view of a modularized ionizer envelope, in accordance with various embodiments.

FIG. 2A illustrates a high voltage board for use in a modularized ionizer envelope, in accordance with various embodiments.

FIG. 2B illustrates a low voltage board for use in a modularized ionizer envelope, in accordance with various embodiments.

FIG. 2C illustrates an electric feedback board for use in a modularized ionizer envelope, in accordance with various embodiments.

### DETAILED DESCRIPTION

The following detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized and that changes may be made without departing from the scope of the disclosure. Thus, the detailed description herein is presented for purposes of illustration only and not of limitation. While these exemplary embodiments are described in sufficient detail to enable those skilled in the art to practice the invention, it should be understood that other embodiments may be realized and that logical, chemical and mechanical changes may be made without departing from the spirit and scope of the invention. For example, the steps recited in any of the method or process descriptions may be executed in any order and are not necessarily limited to the order presented. Furthermore, any reference to singular includes plural embodiments, and any reference to more than one component or step may include a singular embodiment or step. Also, any reference to attached, fixed, connected, or the like may include permanent, removable, temporary, partial, full or any other possible attachment option. Additionally, any reference to without contact (or similar phrases) may also include reduced contact or minimal contact. It should also be understood that unless specifically stated otherwise, references to “a,” “an” or “the” may include one or more than one and that reference to an item in the singular may also include the item in the plural. Further, all ranges may include upper and lower values and all ranges and ratio limits disclosed herein may be combined.

Disclosed herein is an air ionizer system including a modular case and one or more printed circuit boards (PCBs) or circuit board assemblies (CBA). In various embodiments, the modular case may be rectangular in shape and define a top compartment and a front compartment. In various embodiments, the modular case may further include a removable compartment. In various embodiments, the removable compartment may be received into the front compartment to be secured to the modular case. In various embodiments, the operations of the air ionizer may be performed by one or more of a high voltage board, a low voltage board, and a feedback board. In various embodiments, the operations of the high voltage board, the low voltage board, and the feedback board may be described in India patent application No. 202341075178, entitled “Smart Air Ionizer”, filed on Nov. 3, 2023, which is hereby incorporated by reference in its entirety and for all purposes.

The modular case and boards described herein, in their various embodiments, allow for custom air ionizers to be assembled and deployed with little to no variation between the custom air ionizers. In various embodiments, an air ionizer may include the modular case and the high voltage board. In various embodiments, an air ionizer may include the modular case, the high voltage board, and the low voltage board. In various embodiments, an air ionizer may include the modular case, the high voltage board, and the feedback board. In various embodiments, an air ionizer may include the modular case, the high voltage board, the low voltage board, and the feedback board.

As described herein, and in various embodiments, the removable compartment may be configured to physically receive and secure the high voltage board. In various embodiments, the removable compartment may be configured to electrically isolate the high voltage board and shield external components from electromagnetic interference. In various embodiments, the removable compartment may include high dielectric strength materials to prevent or reduce electromagnetic interference. In various embodiments, the removable compartment may be inserted into and secured to the front compartment.

In various embodiments, the low voltage board and the feedback board may be received by and secured to bottom panel in the top compartment. In various embodiments, the bottom panel is a divider between the front compartment and the top compartment. In various embodiments, a communication connector may be coupled to the modular case and operatively coupled to one of the low voltage board or the feedback board. The modularity and flexibility of the various embodiments described herein tends to simplify manufacturing and reduce costs for producing air ionizers. They systems described herein, in their various embodiments, allow for customization of the air ionizers, such as simple or smart air ionizers.

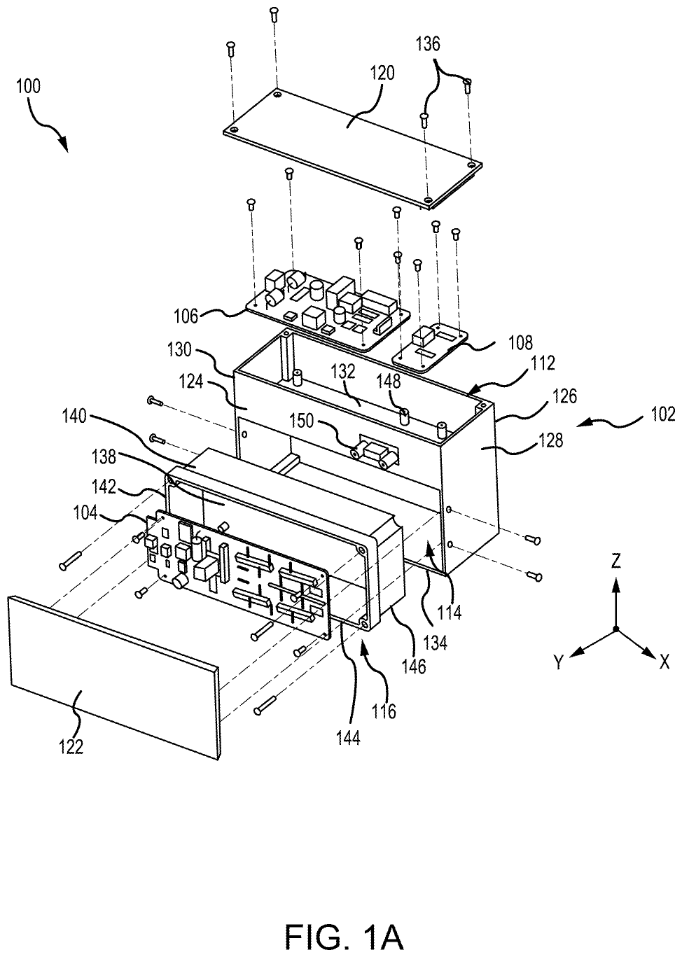

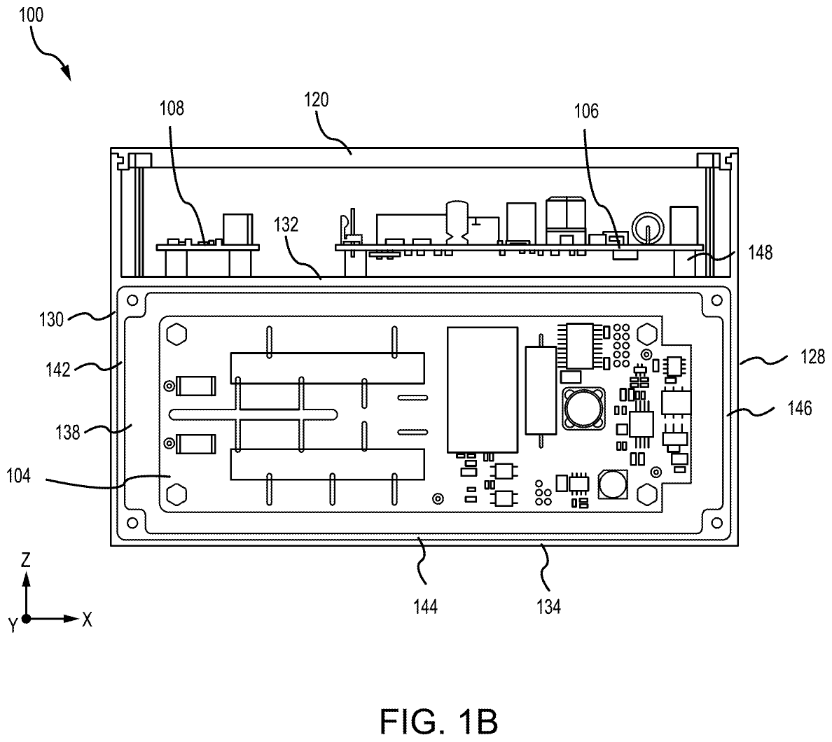

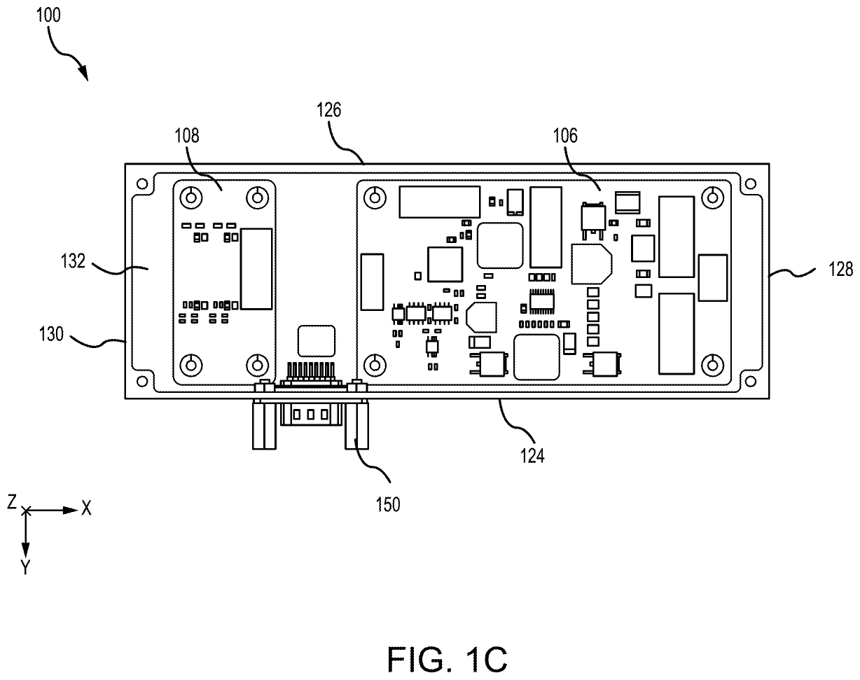

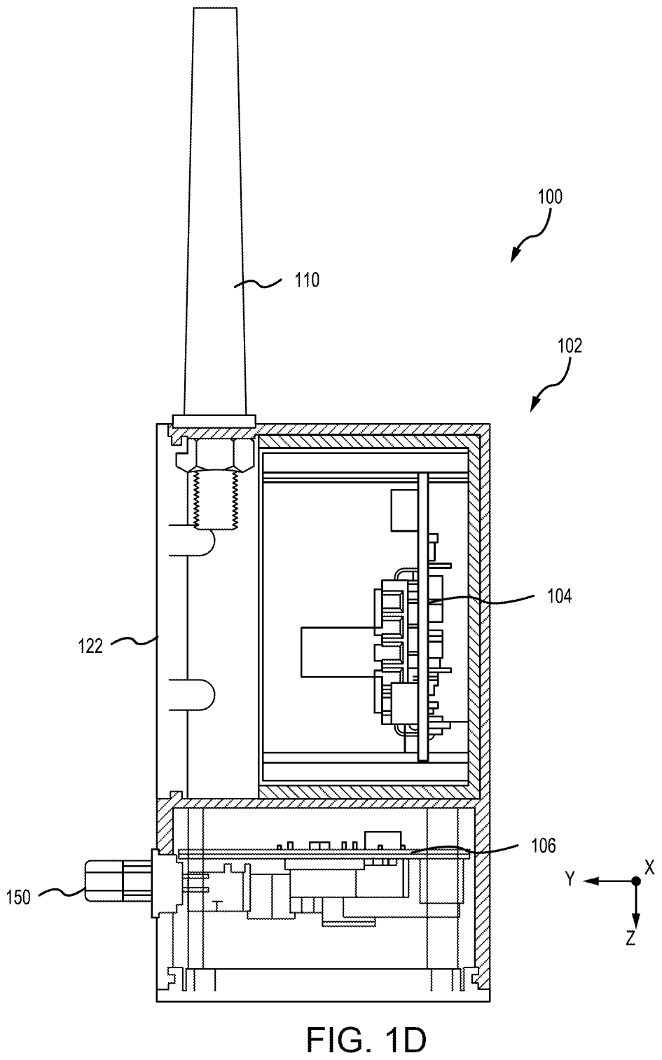

Referring to FIGS. 1A-1D, an air ionizer 100 is illustrated, in accordance with various embodiments. FIG. 1A is an exploded view air ionizer 100, FIG. 1B is a front view of air ionizer 100, FIG. 1C is a top view of air ionizer 100, and FIG. 1D is a side view of air ionizer 100. Air ionizer 100 includes a modular case 102 and any combination of one or more of a high voltage board 104, a low voltage board 106, a feedback board 108, and one or more ion emitters 110. In various embodiments, air ionizer 100 may include modular case 102 and high voltage board 104. In various embodiments, air ionizer 100 may include modular case 102, high voltage board 104, and low voltage board 106. In various embodiments, air ionizer 100 may include modular case 102, high voltage board 104, low voltage board 106, and feedback board 108. In various embodiments, high voltage board 104 may operate at about 2.5 kV to about 12.5 kV, and more specifically, about 5 kV to about 10 kV. In various embodiments, low voltage board 106 may operate at about 18 V to about 120V, and more specifically, about 28 V to about 32 V.

Depending on the desired operational use case, air ionizer 100 may, in various embodiments, be configured to operate in an open loop configuration, a closed loop configuration with a programmable ion count, a closed loop configuration with a ion measurement, or an ion measurement configuration. The open loop configuration includes modular case 102 and high voltage board 104. The closed loop configuration with programmable ion count includes modular case 102, high voltage board 104, and low voltage board 106. The closed loop configuration with ion measurement includes modular case 102, high voltage board 104, low voltage board 106, and feedback board 108. The ion measurement configuration includes modular case 102, low voltage board 106, and feedback board 108.

Modular case 102 includes a top compartment 112, a front compartment 114, a removable compartment 116, a top lid 120, and a front lid 122. Modular case 102 has a front wall 124 (e.g., in the positive y-direction), a back wall 126 (e.g., in the negative y-direction), a first sidewall 128 (e.g., in the positive x-direction), a second sidewall 130 (e.g., in the negative x-direction), a divider 132, and a first bottom panel 134 (e.g., in the negative z-direction).

Removable compartment 116 is configured to physically hold and secure high voltage board 104 in place. Removable compartment 116 is further configured to electrically isolate high voltage board 104 from low voltage board 106 and feedback board 108. In various embodiments, removable compartment 116 is formed from materials having a high dielectric strength to electrically isolate high voltage board 104 and tend to minimize electromagnetic interference from high voltage board 104. In various embodiments, the high dielectric strength may be about 200 V/mm to about 5 kV/mm, and more specifically, about 400 V/mm to about 2 kV/mm. In various embodiments, removable compartment 116 may include holes for receiving one or more fasteners 136 to mechanically secure removable compartment 116 inside front compartment 114. In various embodiments, fasteners 136 may be screws, bolts, clips, or snaps, among others.

Removable compartment 116 includes a second bottom panel 138 (e.g., in the negative y-direction), a third sidewall 140 (e.g., in the positive z-direction), a fourth sidewall 142 (e.g., in the negative x-direction), a fifth sidewall 144 (e.g., in the negative z-direction), and a sixth sidewall 146 (e.g., in the positive x-direction). Second bottom panel 138, third sidewall 140, fourth sidewall 142, fifth sidewall 144, and sixth sidewall 146 define removable compartment 116.

Front compartment 114 is configured to receive and secure removable compartment 116 and front lid 122. Front lid 122 is configured to cover and protect front compartment 114, removable compartment 116, and high voltage board 104. Front compartment 114 is defined by back wall 126, first sidewall 128, second sidewall 130, divider 132, and first bottom panel 134 with an opening facing forward (e.g., in the positive y-direction). In various embodiments, front compartment 114 including one or more of back wall 126, first sidewall 128, second sidewall 130, divider 132, and first bottom panel 134 may be formed from a material having a high dielectric strength to provide EMI protection of low voltage board 106, feedback board 108, and electronics external to air ionizer 100.

Divider 132 is configured to physically receive and secure low voltage board 106 and feedback board 108. In various embodiments, one or more standoffs 148 may be coupled to divider 132. The one or more standoffs 148 may be used to secure low voltage board 106 and/or feedback board 108 to divider 132.

In various embodiments, a communication connector 150 may be coupled to modular case 102. In various embodiments, communication connector 150 may be coupled to feedback board 108 through front wall 124. In various embodiments, communication connector 150 may be used to communicate with feedback board 108, including programming feedback board 108, reading data from feedback board 108, and/or connecting feedback board 108 to a network. In various embodiments, communication connector 150 may be a universal serial bus (USB) connector, such as for example, a type-A, a type-B, a type-C, or a micro-A, among others. In various embodiments, communication connector 150 may be a D-subminiature connector, such as for example, a DA-15, a DB-25, a DC 37, a DD-50, or a DE-09, among others. In various embodiments, communication connector 150 may be a registered jack (RJ) 45 connector, an RJ 11 connector, or an RJ 48 connector, among others.

In various embodiments, the openings and outer edges of modular case 102 include few to no sharp edges. In various embodiments, the openings and outer edges of modular case 102 may be rounded to reduce electromagnetic interference and improve electromagnetic compatibility. In various embodiments, modular case 102 connectors may include a gasket to attenuate radiated electromagnetic signals. In various embodiments, high voltage board 104, low voltage board 106, and feedback board 108 are physically and functionally isolated from each other. In various embodiments, a physical barrier may be placed between low voltage board 106 and feedback board 108 in top compartment 112. In various embodiments, the center of gravity of modular case 102 including one or more of high voltage board 104, low voltage board 106, and feedback board 108 is at the center of modular case 102. Centering the center of gravity within modular case 102 ensures stability and tends to increase the number of locations where air ionizer 100 may be installed. In various embodiments, modular case 102 includes grooves that are configured to receive gaskets to reduce or prevent liquid from entering modular case 102 and electromagnetic interference.

Top lid 120 covers and secures top compartment 112. In various embodiments, top lid 120 includes electromagnetic shielding. In various embodiments, top lid 120 is configured to slid into place over top compartment 112. Modular case 102 may include one or more features (e.g., a channel, a protrusion, etc.) through which top lid 120 may slide. In various embodiments, top lid 120 includes a hinge and may be configured to lift open to expose top compartment 112.

Front lid 122 covers and secures front compartment 114. In various embodiments, front lid 122 includes electromagnetic shielding. In various embodiments, front lid 122 is configured to slid into place over front compartment 114. Modular case 102 may include one or more features (e.g., a channel, a protrusion, etc.) through which front lid 122 may slide. In various embodiments, front lid 122 includes a hinge and may be configured to lift open to expose front compartment 114.

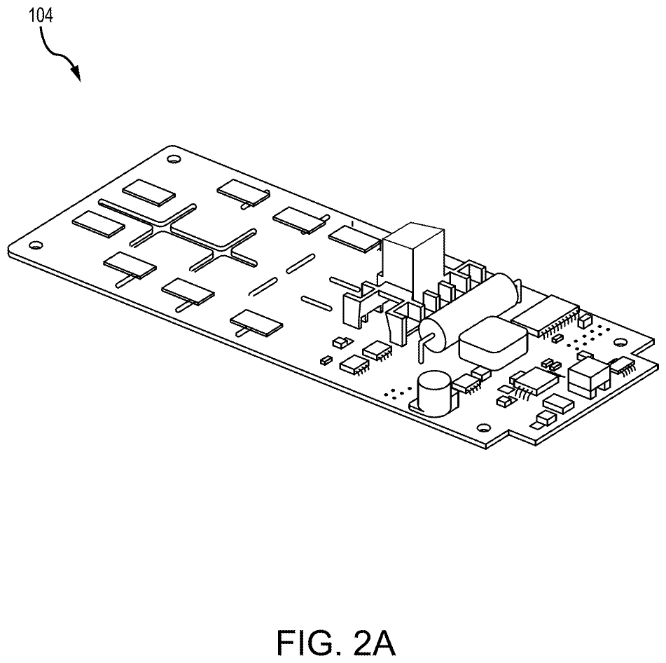

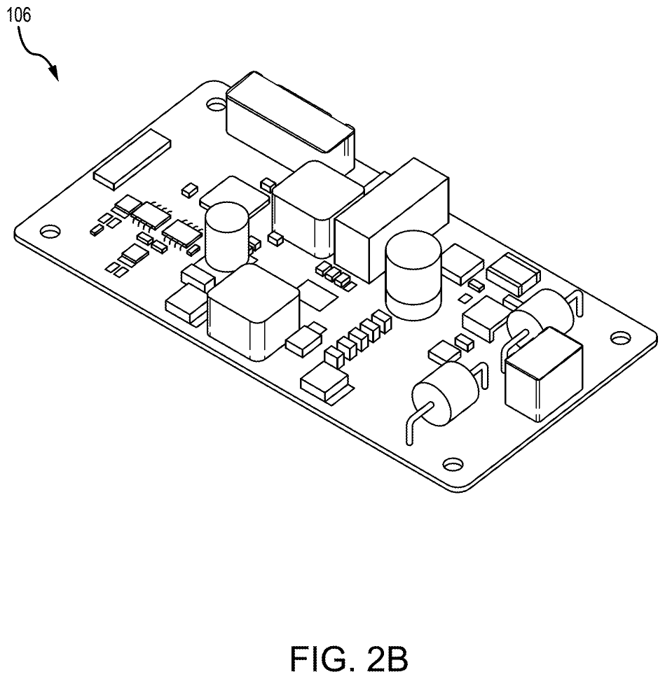

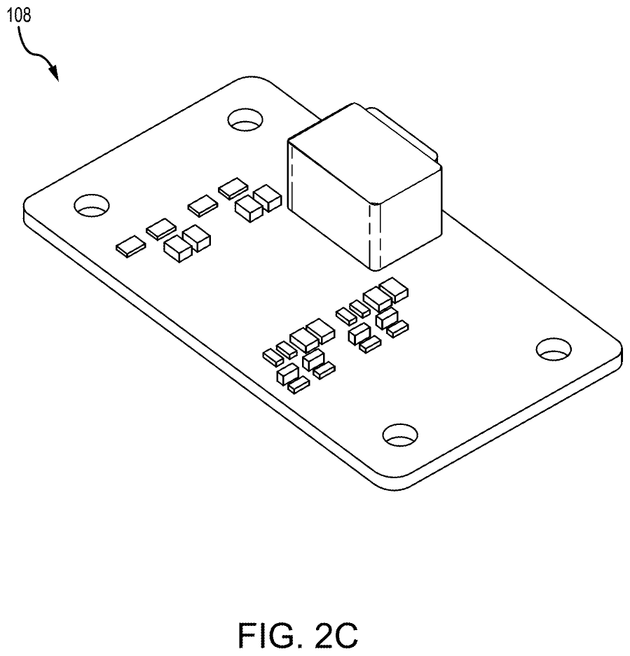

Referring now to FIGS. 2A-2C, high voltage board 104, low voltage board 106, and feedback board 108 are illustrated, in accordance with various embodiments. FIG. 2A illustrates high voltage board 104, FIG. 2B illustrates low voltage board 106, and FIG. 2C illustrates feedback board 108. In various embodiments, each board may be terminated with connectors for easy mounting. In various embodiments, signals passing across boards may be shielded to reduce or minimize electromagnetic interference. In various embodiments, each board may have an interface to modular case 102 for thermal dissipation to minimize thermal impact due to the heat of an adjacent board.

High voltage board 104 converts a low voltage input to a high voltage, low current output. The output of high voltage board 104 is coupled to ion emitter 110, powering ion emitter 110 with the high voltage, low current output. Ion emitter 110 ionizes the air surrounding ion emitter 110 in response to receiving the high voltage, low current input from high voltage board 104. High voltage board 104 may be configured to handle about 5 kV to about 15 kV, and more specifically, about 10 kV. In various embodiments, the component and printed circuit board (PCB) selection, component placement, air gapping, and other design decisions are made to improve the electrical insulation of high voltage board 104 and mitigate dielectric breakdown of the PCB and surrounding components. In various embodiments, high voltage board 104 may be encapsulated in a potting material to further improve the electrical separation and reduce electromagnetic interference and leaks from high voltage board 104.

Low voltage board 106 includes a microcontroller that is configured to control air ionizer 100. In various embodiments, controlling air ionizer 100 includes controlling an ion output count of air ionizer 100. The microcontroller may include one or more processors configured to implement various logical operations in response to execution of instructions, for example, instructions stored on a non-transitory, tangible, computer-readable medium. The one or more processors can be a processing chip, a general purpose processor, a microprocessor, a microcontroller, a digital signal processor (DSP), an application specific integrated circuit (ASIC), a field programmable gate array (FPGA) or other programmable logic device, discrete or transistor logic, discrete hardware components, or any combination thereof. The microcontroller may further comprise memory to store data, executable instructions, system program instructions, and/or controller instructions to implement the control logic of the microcontroller.

Feedback board 108 may be used, in various embodiments, to measure ion count and communicate the ion count to low voltage board 106. In various embodiments, the ion count may be a function of a number of ions and a relevant voltage.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching is used throughout the figures to denote different parts but not necessarily to denote the same or different materials.

Systems, methods, and apparatus are provided herein. In the detailed description herein, references to “one embodiment,” “an embodiment,” “various embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Numbers, percentages, or other values stated herein are intended to include that value, and also other values that are about or approximately equal to the stated value, as would be appreciated by one of ordinary skill in the art encompassed by various embodiments of the present disclosure. A stated value should therefore be interpreted broadly enough to encompass values that are at least close enough to the stated value to perform a desired function or achieve a desired result. The stated values include at least the variation to be expected in a suitable industrial process, and may include values that are within 5% of a stated value. Additionally, the terms “substantially,” “about” or “approximately” as used herein represent an amount close to the stated amount that still performs a desired function or achieves a desired result. For example, the term “substantially,” “about” or “approximately” may refer to an amount that is within 5% of a stated amount or value.

Furthermore, no element, component, or method step in the present disclosure is intended to be dedicated to the public regardless of whether the element, component, or method step is explicitly recited in the claims. No claim element herein is to be construed under the provisions of 35 U.S.C. 122(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

Finally, it should be understood that any of the above-described concepts can be used alone or in combination with any or all of the other above-described concepts. Although various embodiments have been disclosed and described, one of ordinary skill in this art would recognize that certain modifications would come within the scope of this disclosure. Accordingly, the description is not intended to be exhaustive or to limit the principles described or illustrated herein to any precise form. Many modifications and variations are possible in light of the above teaching.

What is claimed is:

1. A modular case for an air ionizer, comprising:
a top compartment having a first opening, the top compartment configured to house a first circuit board;
a removable compartment configured to house a second circuit board, the removable compartment physically and electrically isolating the second circuit board from the first circuit board;
a front compartment having a second opening, the front compartment coupled to and disposed below the top compartment, the front compartment configured to receive and house the removable compartment;
a top lid configured to cover the first opening; and
a front lid configured to cover the second opening.

2. The modular case of claim 1, further comprising:
a front wall;
a back wall;
a first sidewall coupled to the front wall and the back wall;
a second sidewall coupled to the front wall and the back wall; and
a divider coupled to the front wall, the back wall, the first sidewall, and the second sidewall, the divider separating the top compartment from the front compartment,
wherein the front wall, the back, the first sidewall, the second sidewall, and the divider define the top compartment.

3. The modular case of claim 2, further comprising:
a bottom panel coupled to the back wall, the first sidewall, and the second sidewall, wherein the bottom panel, the back wall, the first sidewall, the second sidewall, and the divider define the front compartment.

4. The modular case of claim 1, wherein the first opening opens in a first direction and the second opening opens in a second direction orthogonal to the first direction.

5. The modular case of claim 1, wherein the removable compartment comprises:
a bottom panel;
a first sidewall coupled to a first side of the bottom panel;
a second sidewall coupled to a second side of the bottom panel opposite the first side;
a third sidewall coupled to a third side of the bottom panel and extending from the first sidewall to the second sidewall; and
a fourth sidewall coupled to a fourth side of the bottom panel and extending from the first sidewall to the second sidewall, the fourth side being opposite the third side.

6. The modular case of claim 1, wherein the removable compartment includes a material having a high dielectric to electrically isolate the second circuit board from the first circuit board.

7. The modular case of claim 1, further comprising:
a communication connector coupled to the top compartment, the communication connector configured to operatively connect to the first circuit board.

8. An air ionizer, comprising:
a high voltage circuit board;
a low voltage circuit board operatively coupled to the high voltage circuit board; and
a modular case, including:
a top compartment having a first opening, the top compartment configured to house the low voltage circuit board;
a removable compartment configured to house the high voltage circuit board, the removable compartment physically and electrically isolating the high voltage circuit board from the low voltage circuit board;
a front compartment having a second opening, the front compartment coupled to and disposed below the top compartment, the front compartment configured to receive and house the removable compartment;
a top lid configured to cover the first opening; and
a front lid configured to cover the second opening.

9. The air ionizer of claim 8, wherein the modular case further comprises:
a front wall;
a back wall;
a first sidewall coupled to the front wall and the back wall;
a second sidewall coupled to the front wall and the back wall; and
a divider coupled to the front wall, the back wall, the first sidewall, and the second sidewall, the divider separating the top compartment from the front compartment,
wherein the front wall, the back, the first sidewall, the second sidewall, and the divider define the top compartment.

10. The air ionizer of claim 9, wherein the modular case further comprises:
a bottom panel coupled to the back wall, the first sidewall, and the second sidewall, wherein the bottom panel, the back wall, the first sidewall, the second sidewall, and the divider define the front compartment.

11. The air ionizer of claim 8, further comprising:
a feedback circuit board, wherein the top compartment is further configured to house the feedback circuit board.

12. The air ionizer of claim 8, further comprising:
a communication connector coupled to the top compartment and operatively coupled to the low voltage circuit board.

13. The air ionizer of claim 8, wherein the removable compartment includes a material having a high dielectric to electrically isolate the high voltage circuit board from the low voltage circuit board.

14. The air ionizer of claim 8, wherein the removable compartment comprises:
a bottom panel;
a first sidewall coupled to a first side of the bottom panel;
a second sidewall coupled to a second side of the bottom panel opposite the first side;
a third sidewall coupled to a third side of the bottom panel and extending from the first sidewall to the second sidewall; and
a fourth sidewall coupled to a fourth side of the bottom panel and extending from the first sidewall to the second sidewall, the fourth side being opposite the third side.

15. An air ionizer, comprising:
a high voltage circuit board; and
a modular case, including:
a top compartment having a first opening;
a removable compartment including a high dielectric material and configured to house the high voltage circuit board, the removable compartment physically and electrically isolating the high voltage circuit board from the top compartment;
a front compartment having a second opening, the front compartment coupled to and disposed below the top compartment, the front compartment configured to receive and house the removable compartment;
a top lid configured to cover the first opening; and
a front lid configured to cover the second opening.

16. The air ionizer of claim 15, wherein the removable compartment comprises:
a bottom panel;
a first sidewall coupled to a first side of the bottom panel;
a second sidewall coupled to a second side of the bottom panel opposite the first side;
a third sidewall coupled to a third side of the bottom panel and extending from the first sidewall to the second sidewall; and
a fourth sidewall coupled to a fourth side of the bottom panel and extending from the first sidewall to the second sidewall, the fourth side being opposite the third side.

17. The air ionizer of claim 15, further comprising:
a low voltage circuit board disposed in the top compartment, the low voltage circuit board operatively coupled to the high voltage circuit board.

18. The air ionizer of claim 17, further comprising:
a feedback circuit board disposed in the top compartment and operatively coupled to the low voltage circuit board.

19. The air ionizer of claim 15, wherein the modular case further comprises:
a front wall;
a back wall;
a first sidewall coupled to the front wall and the back wall;
a second sidewall coupled to the front wall and the back wall; and
a divider coupled to the front wall, the back wall, the first sidewall, and the second sidewall, the divider separating the top compartment from the front compartment,
wherein the front wall, the back, the first sidewall, the second sidewall, and the divider define the top compartment.

20. The air ionizer of claim 19, wherein the modular case further comprises:
a bottom panel coupled to the back wall, the first sidewall, and the second sidewall, wherein the bottom panel, the back wall, the first sidewall, the second sidewall, and the divider define the front compartment.
